(19) United States
(12) Patent Application Publication
(10) Pub. No.: US 2016/0012408 A1
(43) Pub. Date: Jan. 14, 2016

(54) CLOUD-BASED MOBILE PAYMENT SYSTEM

(71) Applicant: Nicholas Stanoszek, Strongsville, OH (US)

(72) Inventor: Nicholas Stanoszek, Strongsville, OH (US)

(73) Assignee: PAY(Q)R, LLC, Strongsville, OH (US)

(21) Appl. No.: 14/727,760

(22) Filed: Jun. 1, 2015

Related U.S. Application Data
(63) Continuation-in-part of application No. 14/326,522, filed on Jul. 9, 2014.

(51) Int. Cl. G06Q 20/32; G06Q 20/20; G06Q 20/38; H04L 29/08

(52) U.S. Cl. CPC G06Q 20/322; H04L 67/10; G06Q 20/202; G06Q 20/382; G06Q 20/3278

(57) ABSTRACT

Methods and devices for mobile payment are disclosed including initiating payment processes using a non-secure credential. A secure remote server may store certain sensitive data and may permit a consumer to use the data, for instance, in a retail transaction provided that the consumer can satisfy an authentication challenge. Authentication challenges may include, for instance, supplying PIN number, password, security code, or biometric data.

This application claims the benefit of U.S. patent application Ser. No. 14/326,522 filed on Jul. 9, 2014 and now pending which is incorporated by reference herein in its entirety.

### I. BACKGROUND OF THE INVENTION

A. Field of Invention

Embodiments of the present invention generally relate to mobile payment devices and methods.

B. Description of the Related Art

Various mobile payment systems are known in the art, but each have certain deficiencies. One example of a known mobile payment methodology is referred to as an electronic wallet. Such systems require a user to store sensitive payment credential and/or identity data on a mobile device. Typically, this information is stored on a secure element within the mobile device, and is transmitted in encrypted form. Therefore, if the device is lost or stolen then the data is at risk of being stolen as well. Other known systems require a mobile device to communicate securely with a remote server which then relays sensitive payment or identity credentials to a point of sale system enabling a transaction to take place. While many devices and methods are known for executing electronic transactions from mobile devices, none of the prior art to date has been able to use non-secure credentials to initiate a secure transaction.

Some embodiments of the present invention may provide one or more benefits or advantages over the prior art.

### II. SUMMARY OF THE INVENTION

Some embodiments may relate to a cloud-based mobile payment system, comprising: a mobile computing application executable on a mobile computing device, the mobile computing device being adapted to broadcast a unique non-secure credential according to a non-secure protocol; a point-of-sale computer system adapted to receive the unique non-secure credential and adapted to communicate the unique non-secure credential through a network; and a secure server adapted to store a payment credential in association with a security credential and in association with the unique non-secure credential, and securely communicate the payment credential through the network to either the point-of-sale computer system or a remote credit card processor.

Some embodiments may relate to a cloud-based mobile payment system, comprising: a mobile computing application executable on a mobile computing device, the mobile computing device being adapted to broadcast a Unique Device Identifier (UDID) or Identifier for Advertisers (IDFA) using an unencrypted digitally encoded radio frequency beacon; a point-of-sale computer system adapted to receive the UDID and adapted to communicate the UDID through a network selected from one or more of the Internet, a cellular network, an intranet, or an ad hoc network; the point-of-sale computer system being further adapted to receive a payment credential and a security credential corresponding to the UDID, wherein the point-of-sale computer system is adapted to compare the security credential to a customer input and either allow use of the payment credential if the customer input matches the security credential or deny use of the payment credential if the customer input does not match the security credential; and a secure server adapted to store the payment credential and the security credential in association with the UDID and securely communicate the payment credential and the security credential through the network to the point-of-sale computer system in response to receiving the UDID from the point-of-sale computer system, wherein the security credential is selected from one or more of a password, a personal identification number, a fingerprint, or a retinal scan.

Some embodiments may relate to a cloud-based mobile payment method comprising the steps of: storing a payment credential, a security credential, and a non-secure credential in association with each other on a secure server; the secure server receiving from a remote point-of-sale computer system a non-secure credential corresponding to a retail customer-operated mobile electronic device; comparing the non-secure credential from the point-of-sale computer system to the non-secure credential stored on the secure server and if the non-secure credentials match then causing the point-of-sale computer system to collect a security credential from the customer; and comparing the collected security credential to the security credential stored on the secure server and if the security credentials match then allowing access to the payment credential stored on the secure server.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic drawing of a typical embodiment;

FIG. 2 is a drawing of several mobile electronic devices contemplated by the present invention;

FIG. 3 is a schematic representation of a challenge/response authentication process where authentication occurs on the secure server; and

FIG. 4 is a schematic representation of a challenge/response authentication process where authentication occurs on the point-of-sale computer system.

### IV. DETAILED DESCRIPTION OF THE INVENTION

In broad terms, embodiments of the invention may enable a secure transaction to be initiated by a mobile electronic device using a non-secure data transmission. For instance, a mobile device may broadcast non-secure identification data according to known radio frequency data transmission protocols. This non-secure transmission may be received and/or read by a point-of-sale computer system (POS). The POS may use this information to query a remote server which may securely store sensitive personal identity and/or payment credentials. Furthermore, these sensitive credentials may be stored in relation to the non-secure identification data transmitted by the mobile device. Thus, the non-secure data may be used as a trigger to cause a challenge-response authentication process to commence. More specifically, when the remote server receives the non-secure identification data, the server may compare it to a database of similar data, and if a match is found it may then transmit a challenge such as a request for a PIN number. If the user is able to supply the security credential then the remote server permits the use of the related payment and/or identity credentials to execute a pending transaction.

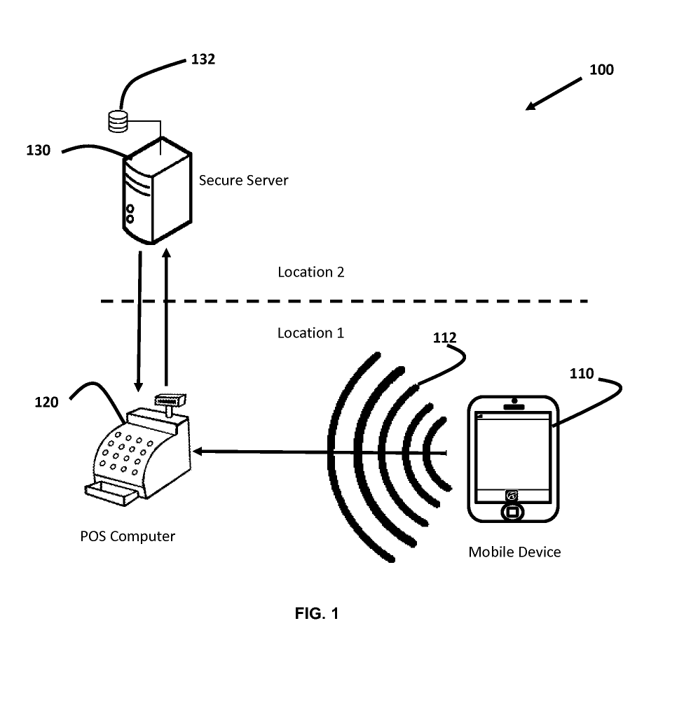

Referring now to the drawings wherein the showings are for purposes of illustrating embodiments of the invention only and not for purposes of limiting the same, FIG. 1 is a schematic drawing of the topology of a typical embodiment 100. The embodiment 100 includes a mobile device 110 which is broadcasting 112 a non-secure credential such as a unique device identifier (UDID) according to a known radio-frequency protocol. In some embodiments the protocol may be Bluetooth Low Energy (BLE); however, other protocols are also within the scope of the invention provided that they are capable of transmitting said data. A POS system 120 may receive the non-secure radio frequency signal and may relay it to a remote secure server 130. Thus, the POS system 120 and the mobile device 110 are at a first location and the remote server 130 is at a second location.

With continuing reference to FIG. 1, the remote server 130 may include a database 132. The database 132 may include certain secure credentials such as credit and debit card numbers, bank account and routing numbers, wire transfer data, personal account number (PAN), and personal identifying data such as name, address, and/or social security number. The secure credential may also include a tokenized form of any of the foregoing credentials, as the term “token” is understood in the context of electronic security applications. Secure credentials within the scope of the present invention, may be any credential that may be used to transact business or that could harmful to its owner if stolen, and that must be protected from theft or unauthorized use. Embodiments will typically encrypt this data on the secure server 130 and database 132, and may comply with Payment Card Industry Data Security Standards (PCI DSS).

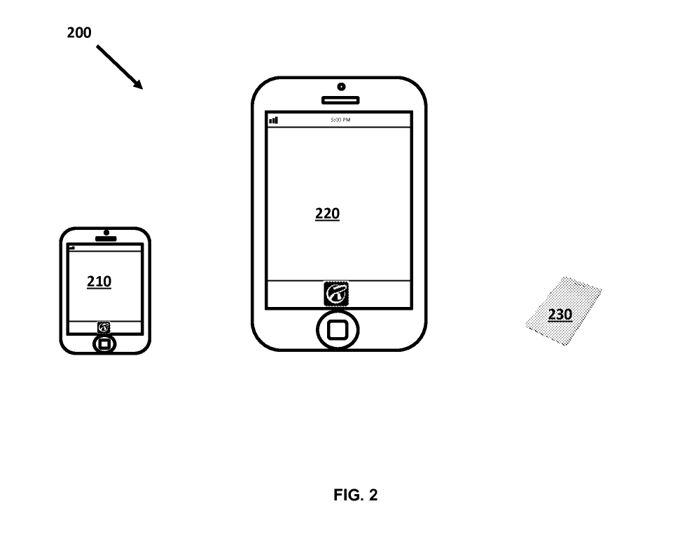

Regarding FIG. 2 it will be understood that mobile devices 200 within the scope of the invention include any electronic device that is typically carried with the user such as, without limitation, a smart phone 210 or tablet computer 220. Suitable devices have the ability to broadcast a non-secure credential. One example of this is a radio frequency beacon operating according the Bluetooth Low Energy (BLE) protocol; however, any digital or analog radio signal can be appropriate for this purpose. Thus, other devices may include low cost purpose-built devices such as an electronic pass card 230 equipped with a simple radio frequency identification tag (RFID tag). Suitable RFID tags may be passive or active. It is understood in the art that passive RFID tags operate by harnessing the energy supplied by a scanning device, whereas active RFID tags operate using their own on-board power supply such as a battery.

With continuing regard to radio frequency beacons, the present invention is not limited to Bluetooth Low Energy (BLE) or RFID. Other known beacons which may be suitable including iBeacon, ANT beacons by Dynastream, Zigbee (IEEE standard 802.15.4-2003), Radio Frequency for Consumer Electronics (RF4CE), Wi-Fi (IEEE 802.11), or Near Field Communications (NFC) to name a few. Some embodiments may preferentially operate over relatively large distances on the order of meters (e.g. BLE). Such embodiments are suited to detecting the presence of, and tentatively identifying (i.e. pre-authentication), a consumer when he/she enters a brick-and-mortar retail store. Such embodiments may or may not further detect when the individual approaches a point-of-sale computer system, such as a cash register, for check out. Accordingly, such an embodiment may be capable of detecting two distinct states of the consumer; one being that the consumer has merely entered the store, and the other being that the consumer is likely ready to make a purchase due to his proximity to the POS computer system.

Embodiments equipped with features for recognizing a consumer upon entry into a brick-and-mortar store without authentication, may also be adapted to push advertising and/or special offers to the consumer. For example, upon entry a consumer may be informed of certain items on sale, or may be provided with offers based on prior purchasing data that may be accessible without authentication. The marketing information used for generating pushed advertising may include offers that are generally applicable to all consumers, and may also include offers that are specific to a given consumer. Furthermore the marketing information may be stored on the remote secure server and/or on a local computer system. For instance, the generally applicable data may be stored locally on a computer system of the brick-and-mortar store, while consumer-specific marketing data may be stored on the remote secure server. Such data stored on the remote secure server may be accessible after only tentatively identifying the consumer, and may be stripped of any personally identifying or otherwise secure data. However, it is also within the scope of the invention to generate consumer-specific offers using sensitive personally identifiable information or otherwise secure data. For example, a personal name may be included in the offer as a means of personalizing the communication. Offers generated in this way may be transmitted to the consumer's device only after positively authenticating the consumer at the point of sale.

Alternatively, embodiments may preferentially operate over relatively short distances on the order of centimeters or millimeters, for instance. Such embodiments may be particularly suitable for initiating a retail transaction, such as a card that is swiped or otherwise read at close range. RFID and NFC technologies may be particularly advantageous for such embodiments. While embodiments may include components for operating over long and short ranges by combining, for instance, BLE and NFC technologies, some embodiments may operate exclusively over short ranges. For instance, such a device would not be recognized by the POS upon entry into a brick-and-mortar store. Instead, the device would be recognized when a consumer carrying the device approaches the POS, e.g. during checkout. Technologies such as NFC and RFID may be particularly suitable for such embodiments; however, embodiments are not limited to such technologies. For example, a BLE signal could be used in such embodiments, but the embodiment would be advantageously configured so that a POS only recognizes BLE signals above a predetermined signal strength which may be used to infer proximity to the POS. This same methodology can be used in connection with any other longer-range signal transmission methodology described herein such as Wi-Fi, iBeacon, etc.

Similar to embodiments that recognize a consumer upon entry, embodiments that only recognize a consumer at the POS may also provide the consumer with offers or coupons. Furthermore, such embodiments may operate in a manner similar to that which was previously described where the consumer is recognized upon entry. More particularly, said similarities may include the manner of storing data, the location where it is stored, and whether or not authentication is required.

The non-secure radio frequency signal that is broadcast by the mobile electronic device may be any indicia which is capable of tentatively identifying a consumer pending authentication. To illustrate, an embodiment may broadcast a unique device identifier (UDID) code. The POS computer system may include a suitable receiver for reading the non-secure UDID code transmission, and may use this code to lookup an authentication challenge which may be stored on the secure remote server 130. For instance, the database 132 of the secure server 130 may store UDID codes in association with payment credentials and authentication challenge/response credentials. The server 130 may therefore use the UDID to challenge the consumer with, for instance, a PIN number request. Provided that the consumer can supply the necessary response, the consumer will be permitted to use the associated payment credentials in a transaction. It will be understood that the invention is not limited to UDID codes and may also include codes consistent with the Identifier for Advertisers (IDFA) standard, or codes that identify the mobile electronic device to a network such as MAC address.

Embodiments of the invention may include a device in communication with the point-of-sale computer system 120 which is capable of reading the non-secure signal 112 of a mobile electronic 110 device used for preliminarily identifying a consumer. Suitable devices may include suitably equipped NFC card readers, or credit/debit card readers; however, suitable devices may additionally or alternatively be Wi-Fi or Bluetooth enabled devices. Regardless of the particular form of the device or the protocol by which it operates, a suitable device will be capable of receiving the non-secure signal and enable the POS computer system to transmit the signal over a network to a remote secure server 130. Any network is within the scope of the invention provided it is capable of making such a transmission. Specifically, the Internet, intranets, local area networks, wide area networks, ad hoc networks, and cellular networks are all contemplated as being particularly suitable. While it is possible that the secure server 130 may be located in the same building as the POS system, a more desirable deployment topology would provide the secure server 130 at a separate location, e.g. in a high-security data center.

With respect to authentication methodologies, in one embodiment a point-of-sale computer system 120 may transmit the non-secure credential of a mobile electronic device 110 to a secure remote server 130 through an encrypted or un-encrypted connection. The server 130 may then look up a challenge and response and may transmit only the challenge to the point-of-sale computer system 120, which may communicate the challenge to the consumer. One way of communicating the challenge to the consumer is through a terminal of the point-of-sale computer system 120. The terminal may have a display viewable by the consumer such as a touch screen or liquid crystal display, and may provide the consumer with a means for responding to a challenge displayed on the screen. Suitable means for responding may be an alphanumeric keypad, and/or a biometric device such as a fingerprint reader or retinal scanner. The invention is not limited to such means of conducting a challenge/response authentication. For instance, embodiments may conduct the challenge response through the consumer's mobile electronic device, e.g. the consumer's smart phone or tablet computer. For instance, the built-in fingerprint reader of many such devices may be suitable for collecting fingerprints for the authentication methods of the present invention.

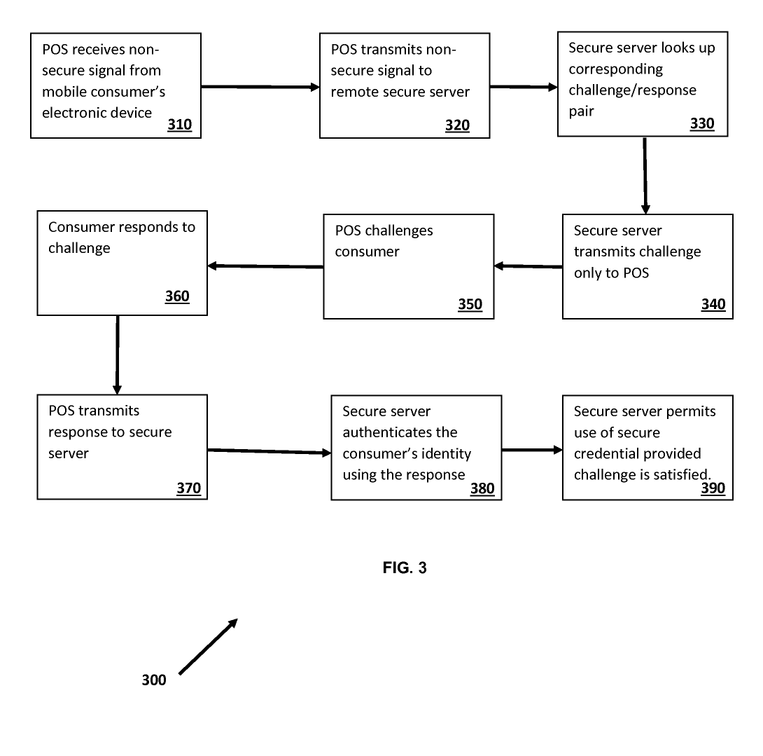

FIG. 3 illustrates how one embodiment conducts a challenge/response authentication 300. A point-of-sale computer system receives 310 the non-secure signal from the consumer's mobile electronic device. The POS transmits 320 the non-secure signal to the remote secure server in encrypted or un-encrypted form. The secure server looks up 330 the corresponding challenge/response pair, and transmits 340 only the challenge to the POS. The challenge may advantageously be transmitted in encrypted form. The POS then challenges 350 the consumer by requesting a PIN, password, or fingerprint for example. The consumer provides 360 a response and the POS transmits 370 the encrypted response back to the secure server. The secure server authenticates 380 the consumer's identity by comparing the consumer's response to a known such as a record of a fingerprint, or a record of a password or PIN number. Provided that the consumer can be authenticated, the secure server may then permit 390 usage of or access to one or more secure credentials such as payment and/or personal identity credentials. The step of permitting may enable, for example, the server to process a credit card payment, to relay the consumer's payment credentials to a third party credit card processor, or to return the encrypted payment credentials to the POS which may then relay them to a third party credit card processor as if the consumer had swiped a physical credit card. Rather than encryption, the remote secure server may transmit the payment credential to the point-of-sale system in tokenized form.

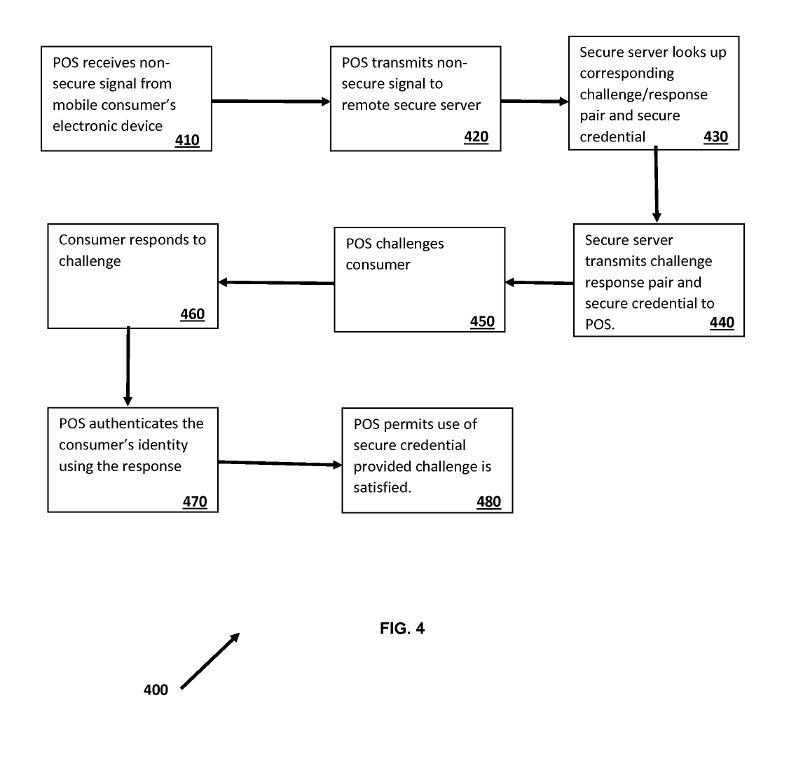

FIG. 4 illustrates a variation 400 of the process set forth in FIG. 3 where authentication takes place on the point-of-sale computer system rather than the secure server. According to FIG. 4, a POS receives 410 a non-secure signal from a consumer's mobile electronic device, and transmits the signal to a remote secure server 420. The server looks 430 up a corresponding challenge/response pair, and at least one secure credential such as a credit card number or other payment or personal identification credential. The challenge response pair and the secure credential(s) are then transmitted 440 in encrypted form back to the POS. The POS challenges 450 the consumer and compares the consumer's response 460 to the known standard 470 thereby authenticating the consumer. Provided that the consumer is authenticated the secure credential held by the POS is then used to complete a transaction as previously described. Embodiments may purge secure data from volatile and/or non-volatile storage after the POS's role in the transaction is complete.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/we claim:

1. A cloud-based mobile payment system, comprising:
a mobile computing application executable on a mobile computing device, the mobile computing device being adapted to broadcast a unique non-secure credential according to a non-secure protocol;
a point-of-sale computer system adapted to receive the unique non-secure credential and adapted to communicate the unique non-secure credential through a network; and
a secure server adapted to store a payment credential in association with a security credential and in association with the unique non-secure credential, and securely communicate the payment credential through the network to either the point-of-sale computer system or a remote credit card processor.

2. The system of claim 1, wherein the non-secure credential comprises a Unique Device Identifier (UDID), an Identifier for Advertisers (IDFA), or a Media Access Control (MAC) address.

3. The system of claim 1, wherein the non-secure protocol comprises an unencrypted digitally encoded radio frequency beacon, or analog radio frequency beacon.

4. The system of claim 3, wherein the radio frequency beacon is selected from one or more of Bluetooth Low Energy, iBeacon, ANT beacons, Zigbee beacons, Radio Frequency for Consumer Electronics beacons, Near Field Communications beacons, active radio frequency identification, or passive radio frequency identification.

5. The system of claim 1, wherein the network comprises one or more of the Internet, a cellular network, an intranet, or an ad hoc network.

6. The system of claim 1, wherein the security credential is selected from one or more of a password, a personal identification number, a fingerprint, a hand print, or a retinal scan.

7. The system of claim 1, wherein the point-of-sale computer system is further adapted to receive a security credential corresponding to the unique non-secure credential and compare the security credential to a customer input and either allow use of the payment credential if the customer input matches the security credential or deny use of the payment credential if the customer input does not match the security credential.

8. The system of claim 7, wherein the secure server is adapted to securely communicate the payment credential through the network to either the point-of-sale computer system or the remote credit card processor in response to receiving confirmation that the customer input matches the security credential, and wherein the payment credential being transmitted to the point-of-sale system or the remote credit card processor is either encrypted or tokenized.

9. The system of claim 7, wherein the point-of-sale computer system is further adapted to receive the payment credential and communicate the payment credential to a remote credit card processor provided that the customer input matches the security credential, and wherein the payment credential being transmitted to the point-of-sale system and/or the remote credit card processor is either encrypted or tokenized.

10. The system of claim 1, wherein the secure server is further adapted to compare the security credential to a customer input and either securely communicate the payment credential to the point-of-sale system or remote credit card processor if the customer input matches the security credential, or not communicate the payment credential to the point-of-sale system or remote credit card processor if the customer input does not match the security credential.

11. The system of claim 10, wherein the payment credential being transmitted to the point-of-sale system or the remote credit card processor is either encrypted or tokenized.

12. A cloud-based mobile payment system, comprising:
a mobile computing application executable on a mobile computing device, the mobile computing device being adapted to broadcast a Unique Device Identifier (UDID) or Identifier for Advertisers (IDFA) using an unencrypted digitally encoded radio frequency beacon;
a point-of-sale computer system adapted to receive the UDID and adapted to communicate the UDID through a network selected from one or more of the Internet, a cellular network, an intranet, or an ad hoc network; the point-of-sale computer system being further adapted to receive a payment credential and a security credential corresponding to the UDID, wherein the point-of-sale computer system is adapted to compare the security credential to a customer input and either allow use of the payment credential if the customer input matches the security credential or deny use of the payment credential if the customer input does not match the security credential; and
a secure server adapted to store the payment credential and the security credential in association with the UDID and securely communicate the payment credential and the security credential through the network to the point-of-sale computer system in response to receiving the UDID from the point-of-sale computer system, wherein the security credential is selected from one or more of a password, a personal identification number, a fingerprint, or a retinal scan, wherein the payment credential being transmitted to the point-of-sale system is either encrypted or tokenized.

13. The system of claim 12, wherein the radio frequency beacon is selected from one or more of Bluetooth Low Energy, iBeacon, or Wi-Fi.

14. A cloud-based mobile payment method comprising the steps of:
storing a payment credential, a security credential, and a non-secure credential in association with each other on a secure server;
the secure server receiving from a remote point-of-sale computer system a non-secure credential corresponding to a retail customer-operated mobile electronic device;
comparing the non-secure credential from the point-of-sale computer system to the non-secure credential stored on the secure server and if the non-secure credentials match then causing the point-of-sale computer system to collect a security credential from the customer; and
comparing the collected security credential to the security credential stored on the secure server and if the security credentials match then allowing access to the payment credential stored on the secure server.

15. The method of claim 14, further comprising the step of the secure server receiving from the remote point-of-sale computer system the security credential collected from the customer.

16. The method of claim 14, further comprising the step of the secure server transmitting the security credential to the point-of-sale computer system.

17. The method of claim 16, further comprising the step of the point-of-sale computer system comparing the collected security credential to the security credential transmitted from the secure server.

18. The method of claim 17, wherein if the security credentials match then allowing access to the payment credential stored on the secure server.

19. The method of claim 18, wherein access to the payment credential comprises one or more of transmitting the payment credential to the point-of-sale computer system, transmitting the payment credential to a remote credit card processor, or the secure server processing payment using the payment credential.

20. The method of claim 14, wherein the mobile electronic device comprises a radio frequency identification tag, a smart phone, a tablet computer, or a near field communication device.
